(19) United States
(12) Patent Application Publication
(10) Pub. No.: US 2025/0026344 A1
(43) Pub. Date: Jan. 23, 2025

(54) METHODS AND DEVICE FOR OPERATING A MOTOR VEHICLE, AND MOTOR VEHICLE

(71) Applicants: CARIAD SE, Wolfsburg (DE); Volkswagen Aktiengesellschaft, Wolfsburg (DE)

(72) Inventors: Bastian HERMANN, Wolfsburg (DE); Thomas GUENTERBERG, Wolfsburg (DE); Robert RÖSSLER, Wolfsburg (DE)

(21) Appl. No.: 18/776,089

(22) Filed: Jul. 17, 2024

(30) Foreign Application Priority Data
Jul. 19, 2023 (DE) 10 2023 119 083.0

(51) Int. Cl. B60W 30/14; B60W 50/08; H04W 4/46

(52) U.S. Cl. CPC B60W 30/143; B60W 50/08; H04W 4/46; B60W 2554/408; B60W 2720/10

(57) ABSTRACT

The disclosure relates to a method for operating a motor vehicle, comprising collecting swarm speed data from a plurality of vehicles other than the motor vehicle along a trajectory of the motor vehicle, wherein the swarm speed data include speed data for straight-ahead travel and speed data for turning travel, determining if there is a turn request of the vehicle, and in response to determining that there is the turn request controlling, the motor vehicle based on the speed data for the turning travel.

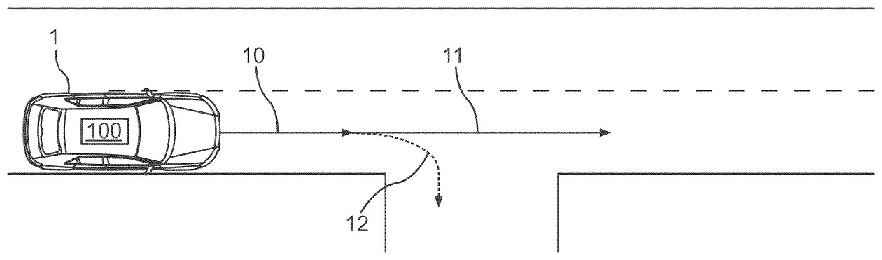

### BACKGROUND

### Technical Field

The present disclosure relates to a method and a device for operating a motor vehicle, and a motor vehicle with such a device.

### Description of the Related Art

Currently, swarm data is used for controlling a motor vehicle. However, it is not clear whether the swarm data is data from a turning maneuver or from straight-ahead travel, which creates ambiguous states.

### BRIEF SUMMARY

Embodiments of the present disclosure provide an improved method and an improved device for operating a motor vehicle, and an improved motor vehicle.

According to a first aspect, a method for operating a motor vehicle is provided.

The method according to the disclosure comprises the steps of collecting swarm speed data from a plurality of vehicles other than the motor vehicle along a trajectory of the motor vehicle, wherein the swarm speed data include speed data for straight-ahead travel and speed data for turning travel, determining if there is a turn request of the vehicle, and in response to determining that there is the turn request, controlling the motor vehicle based on the speed data for the turning travel.

The method according to the disclosure serves in particular to use such swarm speed data which is relevant for straight-ahead travel or turning travel of the vehicle, i.e., to base controlling of the motor vehicle only on such swarm speed data substantially corresponding to the expected trajectory of the motor vehicle.

For this purpose, in a first step, swarm speed data is collected from several vehicles other than the motor vehicle along a trajectory of the motor vehicle.

In particular, speed data is collected from a plurality of vehicles other than the motor vehicle, and recorded. This speed data can be transmitted from the respective vehicles to a remote data center to be combined there to form swarm speed data. This swarm speed data is then available for a plurality of routes, roads or trajectories and can be retrieved from the data center as needed.

Swarm speed data is collected in particular before the current travel during which the motor vehicle is controlled using the method according to the disclosure.

The swarm speed data include both speed data for straight-ahead travel and for turning travel. In the present case, straight-ahead travel comprises staying on the current road or along the present trajectory, whereas turning travel comprises a turning maneuver from the current road into another road. In particular, the straight-ahead travel does not have to be exactly straight, but rather concerns, in particular, a turning maneuver that has not taken place. The swarm speed data for turning travel includes a lower speed, especially average speed, than the swarm speed data for straight-ahead travel, since those vehicles leaving the current road usually slow down before and no later than during said maneuver, in contrast to those vehicles that do not turn.

In particular, however, the swarm speed data does not include any route or trajectory, but it is merely an accumulation of speed values, in particular average values, for given points on the map. How exactly any travel can be identified as a turning travel or a straight-ahead travel will be described below. Said identifying can be done both in the remote data center and in the vehicle itself.

In a further step it is determined, if there is a turn request of the vehicle.

A turn request usually becomes apparent before the turning maneuver itself and can be determined in various ways, as will be described below.

If such a turn request is identified, the motor vehicle is controlled based on the speed data for turning travel.

In this case, in particular, the motor vehicle is a motor vehicle with one or more driving assist functions, such as, for example, a cruise control function, in particular an adaptive cruise control function.

For this purpose, swarm data is usually used for the driving assist function as one of several sources. Other sources may comprise environmental sensors, such as, for example, camera, lidar and/or radar equipment and/or map data, which is also used for the driver assistance function.

According to the disclosure, only such speed data, in particular exclusively such speed data indicating turning travel is used to control the motor vehicle along the turning maneuver, in particular to regulate its speed. Usually, the brake is applied for preparing the motor vehicle as smooth as possible for the turning maneuver.

The method according to the disclosure makes it possible for one or more driving assist functions to be able to act particularly forward-looking and to foresee a turning maneuver in order to initiate a braking maneuver that is as comfortable as possible for the passengers of the vehicle.

According to a refinement, if there is no turn request, the method further comprises the step of controlling the vehicle based on the speed data for straight-ahead travel.

That there is no turn request can be established in particular by exclusion that a turn request is not determined. Alternatively or additionally, there are other possibilities to determine that there is no turn request, which will be described further below.

Thus, according to this refinement, it is identified that the motor vehicle is to stay on the road or on the current trajectory, and thus braking is not initiated. This is done by using such, in particular exclusively such speed data that do not indicate turning travel in order to control the motor vehicle along the turning maneuver, in particular to regulate its speed. Usually, no braking is applied in order to avoid unnecessarily slowing the vehicle down during straight-ahead travel.

This refinement makes it possible to ensure a seamless operation of a driving assist function. In particular, this refinement prevents an unnecessary and abrupt slowing of the motor vehicle at one or more intersections or junctions. This enables a method that is safe, in particular for following vehicles.

According to a refinement, controlling the motor vehicle based on the speed data for turning travel takes place based on a discontinuity of the speed data for turning travel.

In particular, according to this refinement, a discontinuity is identified, which is caused by the fact that, at the turning point itself, both speed data relating to turning travel and speed data relating to straight-ahead travel are available, which results in a discontinuity.

Consequently, according to the disclosure, starting at the turning point, exclusively such speed data relating to turning travel can be used as a basis, as a result of which controlling the speed can be adjusted accordingly during turning travel and thus braking can be achieved.

According to a refinement controlling the motor vehicle takes place based on the speed data for straight-ahead travel based on a discontinuity in the speed data for straight-ahead travel.

Likewise, according to the disclosure, starting at the turning point, exclusively such speed data relating to straight-ahead travel can be used as a basis, as a result of which controlling the speed can be adjusted accordingly during straight-ahead travel and thus braking cannot be achieved.

These refinements enable a particularly exact and therefore comfortable control of the speed of the motor vehicle.

According to a refinement, the distinction between speed data for a straight-ahead travel and for turning travel is based on a comparison of road classes for straight-ahead travel and turning travel.

In particular, speed data along a first trajectory is compared with speed data along a second trajectory, and a distinction is made, as to whether the road along which the second trajectory runs, is a road from a class different from that of the road along which the first trajectory runs.

For example, the road along which the first trajectory runs is a highway where regularly a maximum speed of 70 km/h or 100 km/h is permissible, and at the road along which the second trajectory runs is a secondary road in a residential area where regularly a maximum speed of 30 km/h or walking speed is permissible.

This refinement enables a particularly exact distinction of the speed data.

According to a refinement the distinction in speed data for straight-ahead travel and for turning travel is based on a comparison of curvature angles of the straight-ahead travel and the turning travel.

In particular, speed data along a first trajectory is compared with speed data along a second trajectory, and a distinction is made as to whether the curvature along which the second trajectory runs, is a curvature that is curved more or less than the curvature along which the first trajectory runs.

For example, the curvature along which the first trajectory runs, is a curvature from 0 to 5°, and at the road along which the second trajectory runs, is a curvature from 85° to 95°.

This refinement enables a particularly exact distinction of the speed data.

According to a refinement, the distinction in speed data for a straight-ahead travel and for a turning travel is based on a comparison of target speeds for straight-ahead travel and turning travel.

In particular, such speed data along a first trajectory is compared with speed data along a second trajectory, and a distinction is made as to whether the speed at which the second trajectory is travelled is greater or less than the speed at which the first trajectory is travelled.

This refinement enables a particularly exact distinction of the speed data.

In particular, the distinction between speed data for straight-ahead travel and turning travel is determined or carried out in three stages, carrying out first a comparison of road classes of the straight-ahead travel and the turning travel, followed by a comparison of curvature angles of the straight-ahead travel and the turning travel, after which a comparison of target speeds of the straight-ahead travel and the turning travel is carried out.

According to a refinement, the turn request is determined based on an activation of a motor vehicle function by a driver of the motor vehicle.

An activation of a motor vehicle function comprises in particular activating an indicator in the direction of a turning road and/or positioning and/or orienting the motor vehicle in a turning lane in the direction of a turning road, for example by operating a steering wheel.

In return, a non-existent turn request is identified by an indicator not being activated, in particular not until to a certain point before the turning road, and/or by the motor vehicle positioning itself and/or orienting itself away from the turning road.

This refinement makes it possible for a turn request to be identified particularly precisely.

According to a refinement, the turn request is determined based on an active route navigation of the motor vehicle.

In particular, in this refinement, route navigation to a destination is activated, to which the driving assist functions have access and from which turning or no turning can be inferred, because, for example, route navigation provides for or announces a turning maneuver.

Likewise, it can be determined that there is no request to turn, for example because the route navigation does not provide for or announce a turning maneuver, rather staying on the current road.

This refinement makes it possible for a turn request to be identified particularly precisely.

According to a refinement, the turn request is determined based on an active convoy travel of the motor vehicle with a vehicle ahead.

In particular, in this refinement, the motor vehicle travels in a convoy consisting of at least two motor vehicles that are connected to each other or in contact with each other. This can take place, for example, via Car2X, in particular Car2Car communication, wherein the current motor vehicle follows a motor vehicle ahead which itself turns or indicates a turn request that can be identified by the current motor vehicle, for example by activating an indicator.

In the same way it can also be determined that there is no turn request.

This refinement makes it possible for a turn request to be identified particularly precisely.

According to a refinement the turn request is determined based on a present position of the vehicle on the road.

In particular, position data, for example from a GPS and/or GNSS sensor can be used to determine the side of the road or lane where the motor vehicle is located. Likewise, camera data can be used for this purpose.

In the same way it can also be determined that there is no turn request.

This refinement makes it possible for a turn request to be identified particularly precisely.

In particular, the turn request is determined in the order that, first, a turn request is determined based on an activation of a motor vehicle function by a driver of the motor vehicle. If this cannot be determined, then, a turn request is determined based on an active route navigation of the motor vehicle. If this cannot be determined also, a turn request is determined based on an active convoy travel of the motor vehicle with a vehicle ahead. If this cannot be determined either, a turn request is determined based on the present position of the motor vehicle on the road.

For application scenarios or application situations that may be encountered when carrying out the method and which are not explicitly described here, it may be provided that, according to the method, an error message and/or a request for inputting user feedback is issued and/or a default setting and/or a predetermined initial state is set.

According to a further aspect, a device is provided. The device may have a data processing device or a processor means which is designed to carry out an embodiment of the method according to the disclosure. In particular, the device is designed to communicate with the user terminal of the user and the person, and to cause said person to carry out individual or several steps of the method, as previously described.

For this purpose, the processor can have at least a microprocessor and/or at least a microcontroller and/or at least an FPGA (Field Programmable Gate Array) and/or at least a DSP (Digital Signal Processor). The microprocessor used can be a CPU (Central Processing Units), a GPU (Graphical Processing Unit) or an NPU (Neural Processing Unit). Furthermore, the processor means can have program code which is designed, when carried out by the processor means, to carry out the embodiment of the method according to the disclosure. The program code can be stored in a data memory of the processor means. The processor means can be based, for example, on at least one circuit board and/or on at least one SoC (System on Chip).

According to a further aspect, a motor vehicle is provided comprising such a device.

The motor vehicle according to the disclosure is preferably configured as a motor vehicle, in particular as a passenger car or truck, or as a passenger bus or motorcycle.

As a further solution, the disclosure also comprises a non-transitory computer-readable storage medium, comprising program code, which, when executed by a computer or a computer network, causes said computer or computer network to carry out an embodiment of the method according to the disclosure. The storage medium can be provided at least partially as a non-volatile data storage device (e.g., as a flash memory and/or as an SSD—solid state drive) and/or at least partially as a volatile data storage device (e.g., as a RAM-random access memory). The storage medium can be arranged in the computer or computer network. The storage medium can also be operated, for example, as a so-called app store server and/or cloud server on the Internet. The computer or computer network can be used to provide a processor circuit with, for example, at least one microprocessor. The program code can be provided as binary code and/or as assembler code and/or as source code of a programming language (e.g., C) and/or as a program script (e.g., Python).

The disclosure also comprises combinations of the features of the described embodiments. The disclosure therefore also comprises implementations which, in each case, have a combination of the features of several of the described embodiments, provided the embodiments have not been described as mutually exclusive.

With reference to the embodiments of the device, of the motor vehicle and of the storage medium and the associated advantages, reference is made to the previously described embodiments of the method and the related advantages.

### BRIEF DESCRIPTION OF THE DRAWING

Exemplary embodiments of the disclosure are described below.

The FIGURE shows a schematic top view of an embodiment of a method and a device for operating a motor vehicle.

### DETAILED DESCRIPTION

The exemplary embodiments explained below are advantageous embodiments of the disclosure. In the exemplary embodiments, the described components of the embodiments represent in each case individual features of the disclosure, which are to be considered independently of one other, which, in each case, refine the disclosure also independently of one another. Therefore, the disclosure should also comprise combinations of the features of the embodiments other than those shown. Furthermore, the described embodiments can also be supplemented by further features of the disclosure already described.

The FIGURE shows a schematic view of an embodiment of a method and a device 100 for operating a motor vehicle 1. Device 100 is comprised by motor vehicle 1 and designed to carry out the method steps described below.

Device 100 is designed to collect swarm speed data from several vehicles other than the motor vehicle along a trajectory 10 of motor vehicle 1.

The swarm speed data comprises speed data for straight-ahead travel 11 and for turning travel 12.

Device 100 is designed to determine, if there is a turn request of vehicle 1.

Device 100 is also designed to control motor vehicle 1 based on the speed data for a turning travel 12 when there is a turn request.

Device 100 is also designed to control motor vehicle 1 based on the speed data for straight-ahead travel 11 when there is no turn request.

Device 100 is also designed to control motor vehicle 1 based on a discontinuity of the speed data for straight travel 11 and or turn travel 12.

For this purpose, the distinction between speed data for straight-ahead travel 11 and for turning travel 12 is based on a comparison of road classes of straight-ahead travel 11 and turning travel 12.

The distinction between speed data for straight-ahead travel 11 and for turning travel 12 is also based on a comparison of curvature angles of the straight-ahead travel 11 and the turning travel 12.

The distinction between speed data for straight-ahead travel 11 and for turning travel 12 is based also on a comparison of target speeds of the straight-ahead travel 11 and the turning travel 12.

For this purpose, the turn request is determined based on an activation of a motor vehicle function by a driver of motor vehicle 1.

The turn request is also determined based on an active route navigation of motor vehicle 1.

The turn request is also determined based on an active convoy travel of the motor vehicle with a vehicle ahead (not shown).

The turn request is also determined based on the current position of the motor vehicle on the road.

Overall, the examples show how methods for generating selective swarm speeds at branches, selecting relevant trajectories, and regulating can be provided on discontinuous swarm speed curves.

German patent application no. 10 2023 119 083.0, filed Jul. 19, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a motor vehicle, comprising:
collecting swarm speed data from a plurality of vehicles other than the motor vehicle along a trajectory of the motor vehicle, wherein the swarm speed data include speed data for straight-ahead travel and speed data for turning travel;
determining if there is a turn request of the motor vehicle; and
in response to determining that there is the turn request, controlling the motor vehicle based on the speed data for the turning travel.

2. The method according to claim 1, further comprising:
in response to not determining that there is the turn request, controlling the motor vehicle based on the speed data for the straight-ahead travel.

3. The method according to claim 1, wherein the controlling the motor vehicle based on the speed data for the turning travel is based on a discontinuity of the speed data for the turning travel.

4. The method according to claim 1, wherein a distinction between the speed data for the straight-ahead travel and the speed data for the turning travel is based on a comparison of road classes of the straight-ahead travel and the turning travel.

5. The method according to claim 1, wherein a distinction between the speed data for the straight-ahead travel and the speed data for the turning travel is based on a comparison of curvature angles of the straight-ahead travel and the turning travel.

6. The method according to claim 1, wherein a distinction between the speed data for the straight-ahead travel and the speed data for the turning travel is based on a comparison of target speeds of the straight-ahead travel and the turning travel.

7. The method according to claim 1, wherein the determining if there is the turn request is based on an activation of a motor vehicle function by a driver of the motor vehicle.

8. The method according to claim 1, wherein the determining if there is the turn request is based on an active route navigation of the motor vehicle.

9. A device for operating a motor vehicle, the device comprising:
a processor; and
a memory storing program code that, when executed by the processor, causes the device to:
collect swarm speed data from a plurality of vehicles other than the motor vehicle along a trajectory of the motor vehicle, wherein the swarm speed data include speed data for straight-ahead travel and speed data for turning travel;
determine if there is a turn request of the motor vehicle; and
in response to determining that there is the turn request, control the motor vehicle based on the speed data for the turning travel.

10. A motor vehicle, comprising a device according to claim 9.
